(19) United States
(12) Patent Application Publication
(10) Pub. No.: US 2016/0200510 A1
(43) Pub. Date: Jul. 14, 2016

(54) MANUAL CART LATCH

(71) Applicant: Kann Manufacturing Corporation, Guttenberg, IA (US)

(72) Inventors: Jared ROWLAND, Dyersville, IA (US); Kenneth GOEDKEN, Dubuque, IA (US)

(21) Appl. No.: 14/994,870

(22) Filed: Jan. 13, 2016

Related U.S. Application Data
(60) Provisional application No. 62/103,155, filed on Jan. 14, 2015.

(51) Int. Cl. B65F 3/04

(52) U.S. Cl. CPC B65F 3/04; B65F 2003/0223

(57) ABSTRACT

An attachment for a side loading refuse vehicles wherein the attachment can secure several different types of refuse containers. The attachment is operated without electronics and hydraulics, thus making retrofitting already in-use refuse vehicles easy and inexpensive.

### CROSS-REFERENCE TO RELATED APPLICATIONS

The present application claims priority to provisional patent application 62/103,155 which was filed on Jan. 14, 2015, and is hereby expressly incorporated by reference in its entirety.

### BACKGROUND

Due to the variety of existing carts and containers utilized to hold refuse, different mechanisms are required to lift and empty such carts and containers into a refuse collection device.

It is an object of the invention to provide an attachment that can lift and empty several types of refuse carts and containers.

It is also an object of the invention to have an attachment that does not rely on hydraulics.

### SUMMARY OF THE INVENTION

The present invention provides a solution to engage a variety of carts and containers utilized to store refuse. The invention is an attachment selectively mountable to a side loader refuse collection vehicle. A secondary adapter can be removed from the attachment to facilitate the engagement of a particular cart or container.

### BRIEF DESCRIPTION OF THE DRAWINGS

FIG. 1 is a perspective view of the attachment without a secondary adapter;

FIG. 2 is a perspective view of the attachment with the secondary adapter;

FIG. 3 is a perspective view of the attachment on a side loader;

FIG. 4 is a perspective view of the attachment on a side loader and engaging a container.

### DETAILED DESCRIPTION

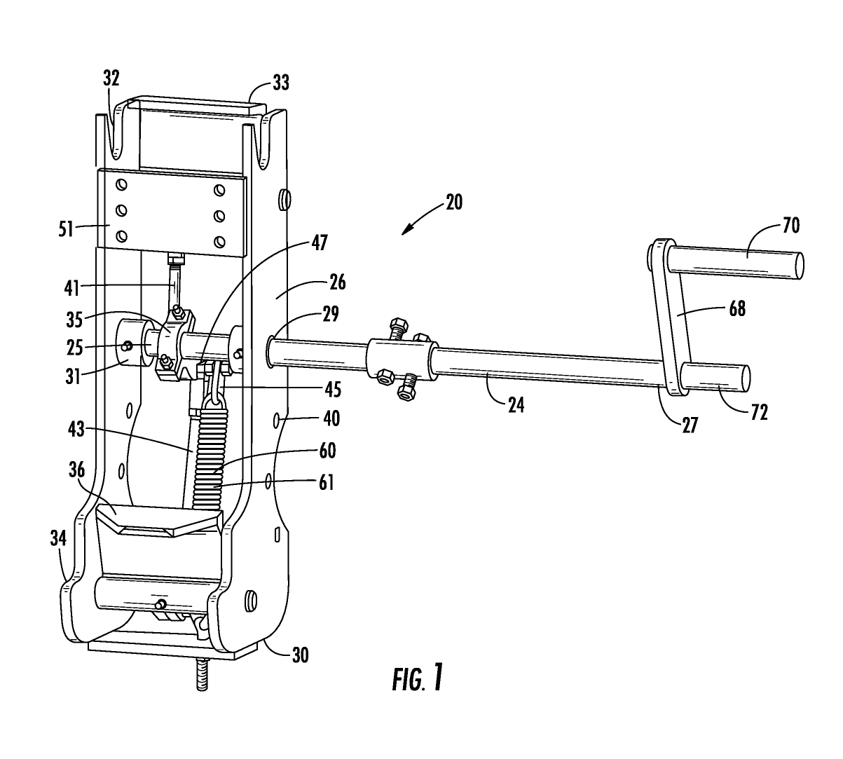

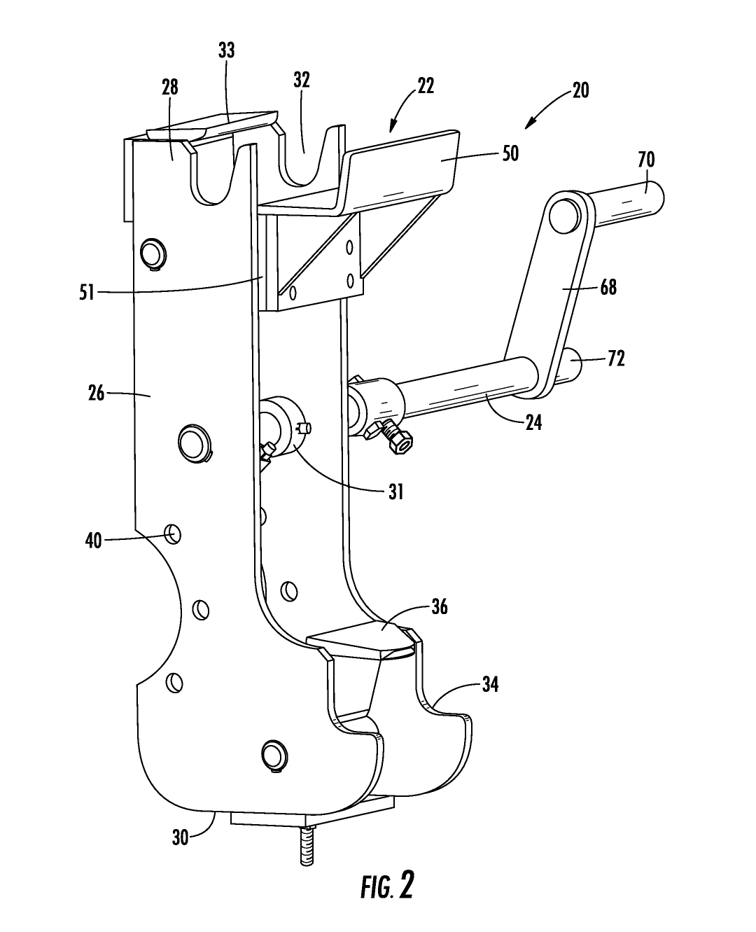

Now referring to the figures, FIG. 1 shows an attachment 20 without a secondary adapter. FIG. 2 shows an attachment 20 with the secondary adapter 22. As shown in FIGS. 1 and 2, the attachment 20 has a main body 26 with a top 28 and a bottom 30. A first type of refuse container can be engaged by the attachment 20 via upper grooves 32 and lower grooves 34. Preferably the upper grooves are U-shaped. Typically bars of the first type of refuse container are captured in the grooves 32 and 34. A second type of refuse container 82 can be engaged by the attachment 20 with the use of the secondary adapter 22. When the adapter 22 is mounted on the attachment 20 the U-shaped grooves 32 are not utilized.

The attachment 20 comprises a rod 24 having a first end 25 and a second end 27. The first end 25 of the rod 24 is inserted through the main body 26 through an opening 29 in the main body 26. A pair of housings 31 located on inner walls of the main body assist with attaching the rod 24 to the main body 26. The second end 27 is attached to a cross member 68 which is further attached to a first engagement member 70 and a second engagement member 72. The engagement members 70 and 72 engage a particular section of an existing side loading mechanism 80 of a refuse collection vehicle.

A clamp 35 encloses the rod 24 and connects the rod 24 to a first linkage 41 and a second linkage 43. The first linkage 41 is connected to a first locking member 33. The second linkage 43 is connected to a second locking member 36. The second linkage 43 is in communication with a biasing member 60 which can be a spring 61. Preferably the spring 61 can be attached to a flange 45 that is then connected to a first end 47 of the second linkage 43.

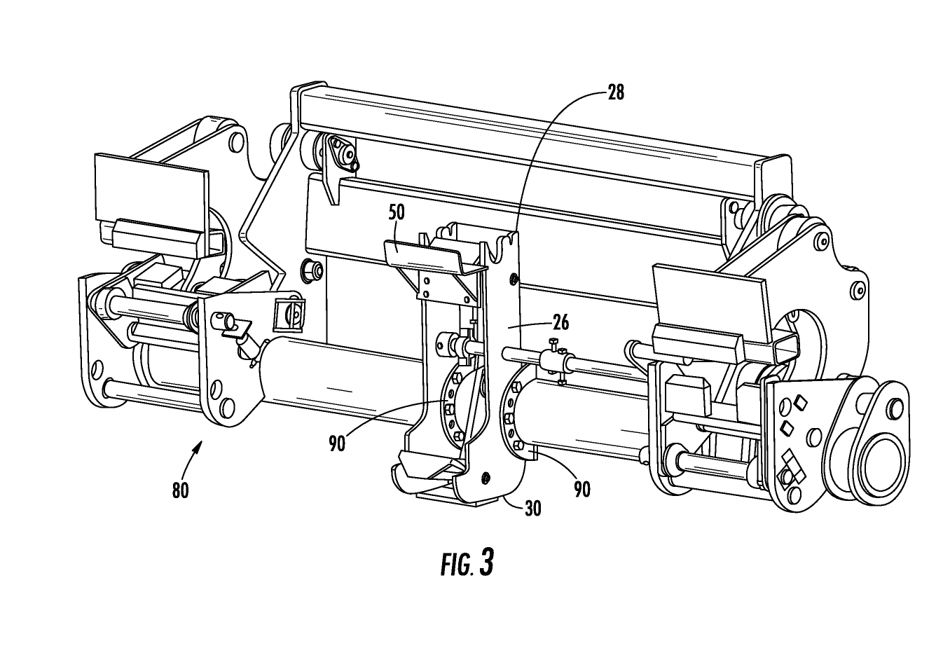

As seen in FIG. 3, the attachment 20 is connected to the side loading mechanism 80 by means of a pair of connecting members 90 which can be bolted to attachment 20 utilizing openings 40. The attachment 20 can be used without the secondary adapter 22. The secondary adapter 22 comprises an L-shaped bar 50 supported by a pair of flanges 52. In order to utilize the secondary adapter 22, the adapter 22 is fastened to a mounting plate 51 of the attachment 20. The user can selectively choose whether to remove or connect the adapter 22 to the attachment 20 depending on the container or cart to be picked up by the attachment 20.

When the side loading mechanism is activated, a component of the first type of refuse container is engaged by the attachment 20. A first portion of the refuse container is within the upper grooves 32 while a second portion of the refuse container is within the lower grooves 34. Through the use of a manual action by the user, the members 70 and 72 are manipulated such that the rod 24 is rotated in a first direction relative to the attachment 20. The rotation of the rod 24 also rotates the clamp 35. As the clamp 35 is connected to the first linkage 41, the second linkage 43, and the spring 61, these particular parts are affected as well by the rotation. The rotation moves the first linkage 41 such that it moves the first locking member 33 over the first portion of the refuse container and secures the first portion. Similarly, the rotation moves the second linkage 43 such that it moves the second locking member 36 over the second portion of the refuse container. The spring 61 moves along with the second linkage 43. The tension in the spring 61 then provides a force that can maintain the locking members 33 and 36 in place. The spring 61 biases the locking members 33 and 36 in the locked position so the container 82 will not disengage from the attachment 20 when the container 82 is inverted.

The refuse container can then be emptied through the existing side loading mechanism. In order to disengage the container from the apparatus 20, the opposite procedure is utilized. The rod is rotated the opposite direction with a force to overcome the force of the spring. The locking members then no longer secure the first or second portion of the refuse container. Accordingly, the refuse container can be placed back at its original location.

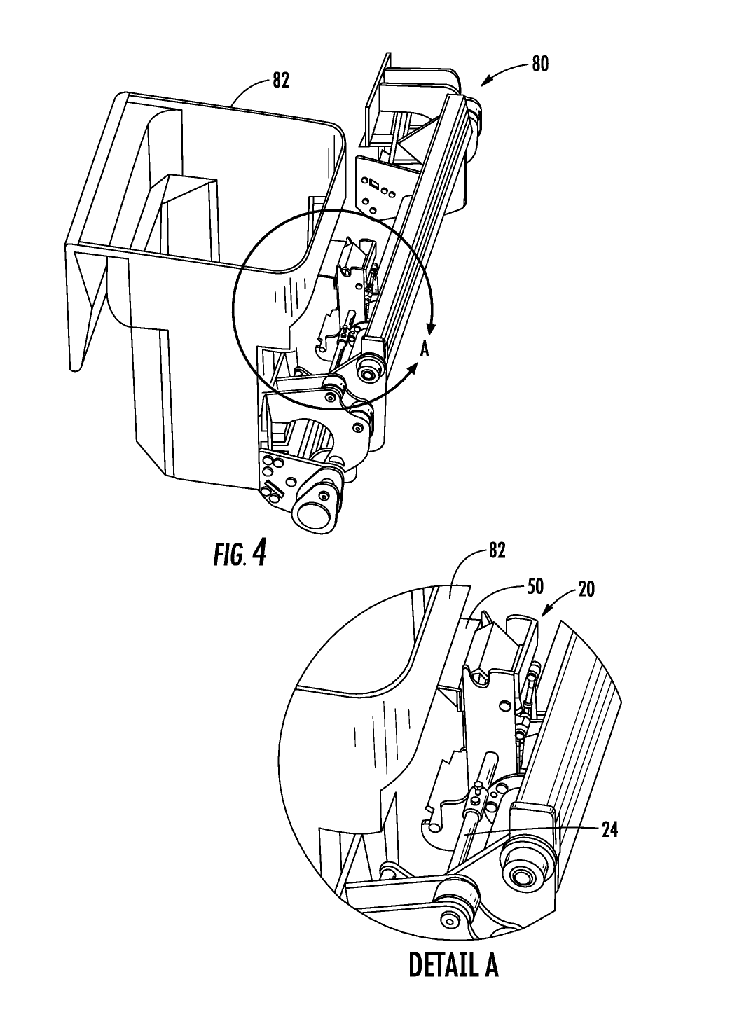

When the secondary adapter 22 is in use, the attachment 20 works in the same way, however, the second portion of the second type of refuse container will not be within the upper grooves 32. Instead, the second portion will be located in the L-shaped bar 50 as shown in FIG. 4. Accordingly, although the first locking member 33 will rotate it will not secure the second portion. The first portion of the second type of refuse container will be secured by the second locking member 36.

While the present invention has been particularly shown and described with reference to exemplary embodiments thereof, it should be understood by those of ordinary skill in the art that various changes, substitutions and alterations can be made herein without departing from the scope of the invention as defined by appended claims and their equivalents.

What is claimed is:

1. An attachment for a side loading refuse collection vehicle, comprising:
a main body;
at least one upper groove;
at least one lower groove;
at least one upper securing member;
at least one lower securing member;
wherein a portion of a first type of refuse container can be located in the grooves;
a biasing member;
a rod connected to the biasing member;
wherein the rod can be rotated to effect the biasing member to selectively maintain a force to secure the first type of refuse container within the grooves.

2. The attachment of claim 1, wherein:
the biasing member is a spring.

3. The attachment of claim 2, wherein:
the main body having a first end and a second end;
the at least one upper groove located at the first end;
the at least one lower groove located at the second end.

4. The attachment of claim 3, further comprising:
a first locking member;
wherein the first locking member securing a portion of the first type of refuse container.

5. The attachment of claim 4, further comprising:
a second locking member;
wherein the second locking member securing a second portion of the first type of refuse container.

6. The attachment of claim 5, wherein:
the rod is attached to a cross member.

7. The attachment of claim 6, further comprising:
a first engagement member.

8. The attachment of claim 7, further comprising:
a second engagement member.

9. The attachment of claim 8, further comprising:
a selectively attachable secondary adapter;
wherein the secondary adapter capable of securing a second type of refuse container.

10. The attachment of claim 9, wherein:
the attachment is operated manually.

11. An attachment for a side loading refuse collection vehicle, comprising:
a main body;
at least one upper groove;
at least one lower groove;
at least one upper securing member;
at least one lower securing member;
a secondary adapter;
wherein a portion of a first type of refuse container can be secured by the secondary adapter;
a biasing member;
a rod connected to the biasing member;
wherein the rod can be rotated to effect the biasing member to selectively maintain a force to secure the first type of refuse container within the at least one lower groove.

12. The attachment of claim 11, wherein:
the secondary adapter comprises a bar.

13. The attachment of claim 12, wherein:
the bar is L-shaped.

14. The attachment of claim 13, wherein:
the secondary adapter is supported by a first flange and a second flange.

15. The attachment of claim 14, wherein:
the rod is attached to a cross member.

16. The attachment of claim 15, wherein:
the cross member is attached to a first engagement member and a second engagement member.

17. The attachment of claim 16, wherein:
the first engagement member and the second engagement member are selectively attachable to the refuse collection vehicle.

18. The attachment of claim 17, wherein:
linkage members connect the rod to the first and second locking members.

19. The attachment of claim 18, wherein:
the biasing member is a spring.

20. An attachment for a side loading refuse collection vehicle, comprising:
a main body;
at least one upper groove;
at least one lower groove;
at least one upper securing member;
at least one lower securing member;
wherein a portion of a first type of refuse container can be located in the grooves;
a biasing member;
a rod connected to the biasing member;
wherein the rod can be rotated to effect the biasing member to selectively maintain a force to secure the first type of refuse container within the grooves
the biasing member is a spring;
a first locking member;
wherein the first locking member securing a portion of the first type of refuse container;
a second locking member;
wherein the second locking member securing a second portion of the first type of refuse container.
